(19) United States
(12) Patent Application Publication
(10) Pub. No.: US 2018/0111436 A1
(43) Pub. Date: Apr. 26, 2018

(54) PROPORTIONAL RADIAL LOADING SPRING ISOLATOR

(71) Applicant: Vibracoustic North America L.P., South Haven, MI (US)

(72) Inventor: Mickey L. Love, Londonderry, NH (US)

(21) Appl. No.: 15/792,082

(22) Filed: Oct. 24, 2017

Related U.S. Application Data
(60) Provisional application No. 62/412,906, filed on Oct. 26, 2016.

(51) Int. Cl. B60G 11/16; F16F 1/12; B60G 11/22; F16F 1/373

(52) U.S. Cl. CPC B60G 11/16; F16F 1/126; B60G 2204/124; F16F 1/3732; F16F 2230/0005; B60G 11/22

(57) ABSTRACT

A spring isolator assembly may include an outer shell with a spring track, an inner wall, and an outer wall for receiving a coil of a spring. The spring track may be disposed between the inner wall and the outer wall. The assembly may also include an insert disposed within the outer shell and includes an angled portion disposed between an inner portion and an outer portion. The insert may include a plurality of holes configured to receive the outer shell. The outer shell may include an inner ring disposed adjacent to the inner wall. The outer shell may include at least one spline configured about the inner diameter of the inner ring. The spring isolator may include at least one spline. The outer shell may include an alignment guide.

### CROSS-REFERENCE TO RELATED APPLICATIONS

This application claims the benefit of U.S. provisional application No. 62/412,906, filed 26 Oct. 2016 (the '906 application). The '906 application is hereby incorporated by reference as though fully set forth herein.

### BACKGROUND

### a. Technical Field

The present disclosure relates to spring isolators, including methods and systems pertaining to proportional radial loading spring isolators.

### b. Background Art

This background description is set forth below for the purpose of providing context only. Therefore, any aspects of this background description, to the extent that it does not otherwise qualify as prior art, is neither expressly nor impliedly admitted as prior art against the instant disclosure.

A coil (e.g., helical), spring may be used to store energy (e.g., loads), temporarily and/or absorb vibration and/or sharp impacts (e.g., shocks). A coil spring may be engaged by a spring isolator. The spring isolator may provide support and/or affect the movement of the coil spring in a particular direction. The spring isolator may be attached to and/or in contact with a larger supporting member, such as a spring seat and/or a vehicle chassis and/or suspension. The spring isolator may maintain the lateral and/or fore/aft direction of the coil spring during compression and/or expansion of a vehicle suspension, as well as at rest. Among other things, it may be desirable to provide a spring isolator that provides proportional (e.g., consistent), radial loading during compression and/or expansion of a coil spring. It may also be desirable to provide a spring isolator that affects the movement of the coil spring. In that regard, it may be desirable to provide a spring isolator system in which the movement of the coil spring in the lateral and/or fore/aft directions may be affected by the spring isolator.

The foregoing discussion is intended only to illustrate the present field and should not be taken as a disavowal of claim scope.

### SUMMARY

In an embodiment, a spring isolator assembly includes an outer shell, wherein the outer shell includes a spring track and an inner wall for receiving a spring and an insert, wherein the insert is disposed within the outer shell and includes an angled portion disposed between an inner portion and an outer portion.

In an embodiment, a spring isolator assembly includes an insert that may include a plurality of holes configured to receive the outer shell.

In an embodiment, a spring isolator assembly includes an insert that may be constructed of a polymer or a metal.

In an embodiment, a spring isolator assembly includes an outer shell that may include an inner ring disposed adjacent to the inner wall.

In an embodiment, a spring isolator assembly includes an outer shell that may be constructed of rubber, microcellular urethane, or foam urethane elastomer.

In an embodiment, a spring isolator assembly includes an outer shell that may include an alignment guide for engaging an end of the spring.

In an embodiment, a spring isolator assembly includes an alignment guide that may be disposed on the spring track and the inner wall.

In an embodiment, a spring isolator assembly includes an outer shell and an insert that may be configured to restrict the movement of the spring relative to at least one of the spring isolator assembly and a vehicle suspension.

In an embodiment, a spring isolator assembly may engage at least one of a body stub, a vehicle chassis, and a vehicle suspension via at least one of an interference fitting, an adhesive, a rivet, and a bolt.

In an embodiment, a spring isolator assembly includes an outer shell, wherein the outer shell includes a spring track, an inner wall, and an outer wall for receiving a coil of a spring, wherein the spring track is disposed between the inner wall and the outer wall, and an insert, wherein the insert is disposed within the outer shell and includes an angled portion disposed between an inner portion and an outer portion.

In an embodiment, a spring isolator assembly includes an insert that may include a plurality of holes configured to receive the outer shell.

In an embodiment, a spring isolator assembly includes an insert that may be constructed of a polymer or a metal.

In an embodiment, a spring isolator assembly includes an outer shell that may include an inner ring disposed adjacent to the inner wall.

In an embodiment, a spring isolator assembly includes an outer shell that may include at least one spline configured about the inner diameter of the inner ring.

In an embodiment, a spring isolator assembly includes at least one spline that may be configured to selectively engage at least one of a body stub, a vehicle chassis, and a vehicle suspension.

In an embodiment, a spring isolator assembly includes at least one spline that may be configured for evacuation of at least one of water and debris between the at least one spline and the at least one of a body stub, a vehicle chassis, and a vehicle suspension.

In an embodiment, a spring isolator assembly includes an outer shell that may be constructed of rubber, microcellular urethane, or foam urethane elastomer.

In an embodiment, a spring isolator assembly includes an alignment guide that may engage an end of a spring.

In an embodiment, a spring isolator assembly includes an alignment guide that may be disposed between an inner wall, a spring track, and an outer wall.

In an embodiment, a spring isolator assembly includes an outer shell and an insert that may be configured to restrict the movement of a spring relative to at least one of a spring isolator assembly and a vehicle suspension.

In an embodiment, a spring isolator assembly may engage at least one of a body stub, a vehicle chassis, and a vehicle suspension via at least one of an interference fitting, an adhesive, a rivet, and a bolt.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1 is a perspective view generally illustrating a first embodiment of a spring isolator, in accordance with teachings of the present disclosure.

FIGS. 2A-2D are top, sectional, and perspective views, respectively, generally illustrating a second embodiment of the spring isolator, in accordance with teachings of the present disclosure.

FIG. 3A is a partial sectional view generally illustrating a body stub associated with embodiments of the spring isolator, in accordance with teachings of the present disclosure.

FIGS. 3B-3C is a partial sectional view and a bottom view, respectively, generally illustrating an insert generally associated with embodiments of the spring isolator, in accordance with teachings of the present disclosure.

FIG. 4 is a top view generally illustrating a section of a coil spring associated with an embodiment of a spring isolator, in accordance with teachings of the present disclosure.

FIGS. 5A-5B are partial sectional perspective views generally illustrating body stubs associated with embodiments of a spring isolator in a jounce loading and radial and jounce loading situation, respectively, in accordance with teachings of the present disclosure.

FIG. 6 is a sectional view generally illustrating a body stub associated with an embodiment of a spring isolator, in accordance with teachings of the present disclosure.

FIG. 7 is a perspective view generally illustrating a vehicle suspension system associated with an embodiment of a spring isolator, in accordance with teachings of the present disclosure.

FIG. 8 is a sectional view generally illustrating a vehicle suspension system associated with an embodiment of a spring isolator, in accordance with teachings of the present disclosure.

### DETAILED DESCRIPTION

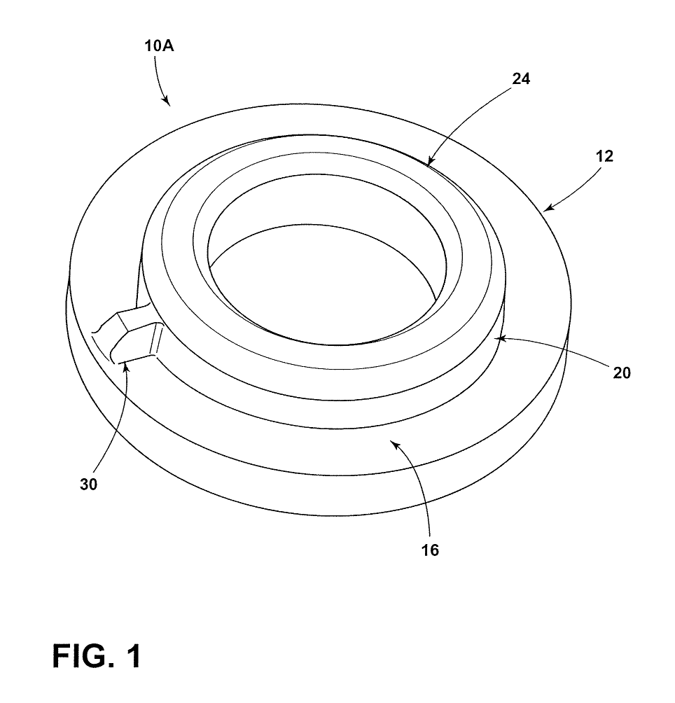

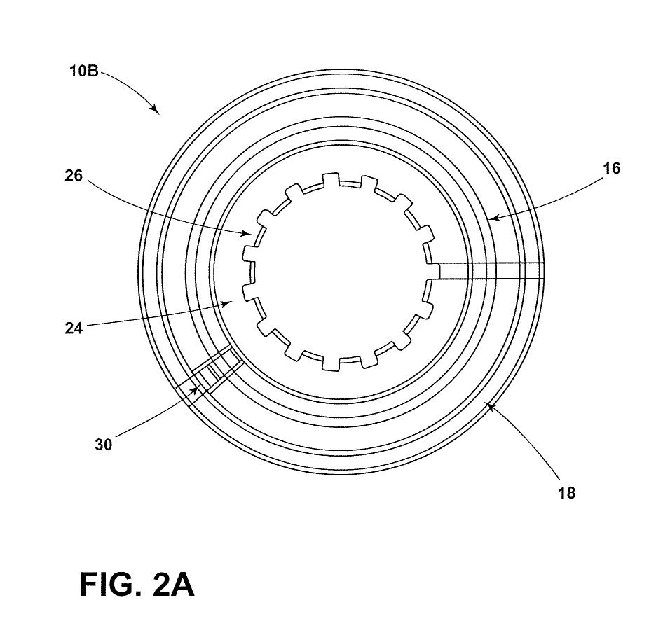

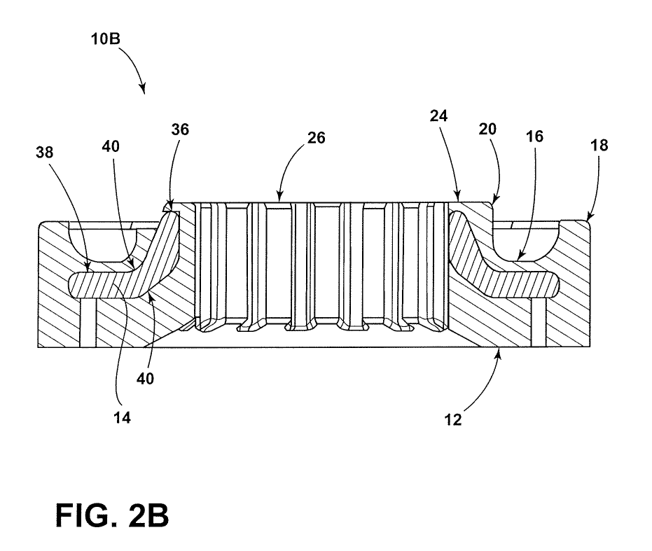

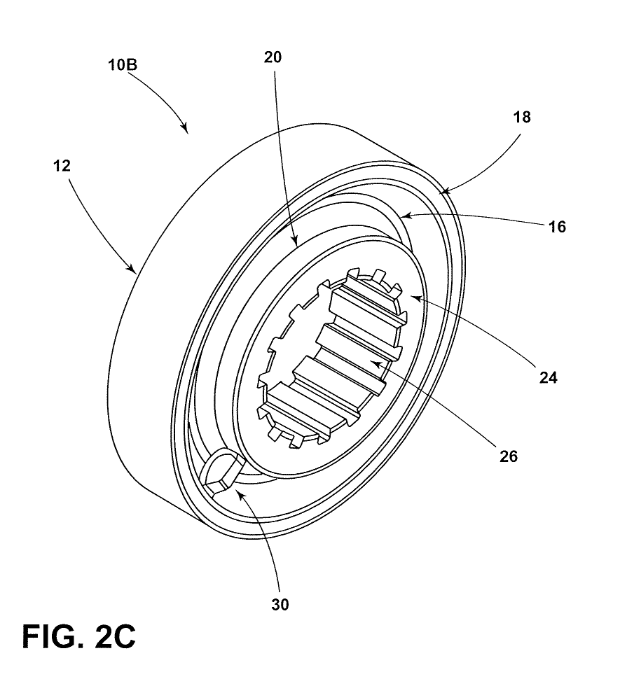

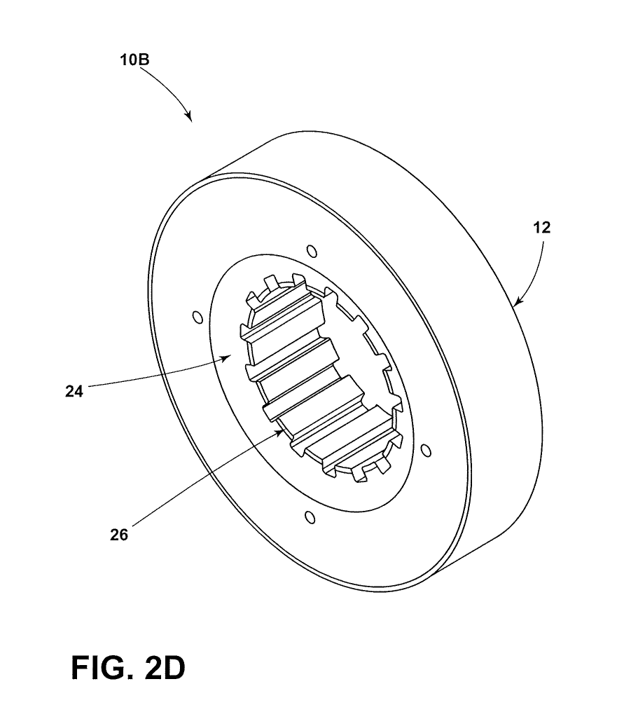

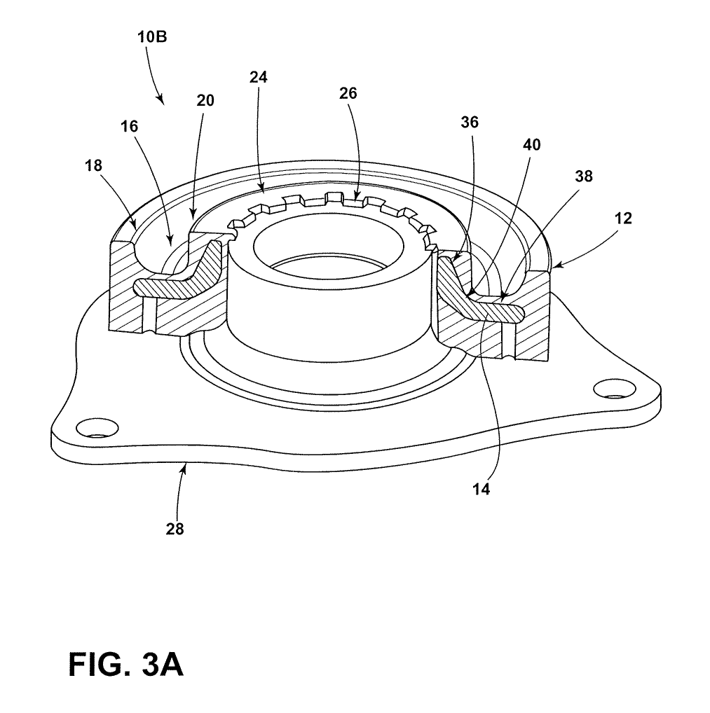

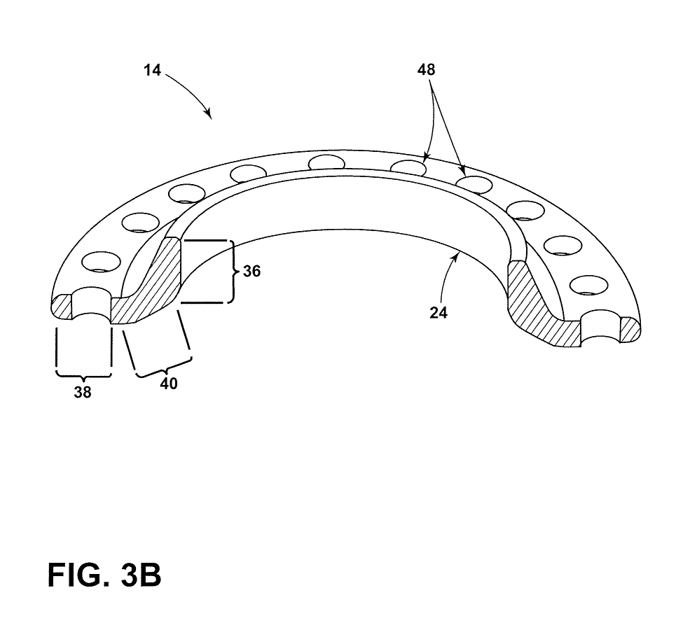

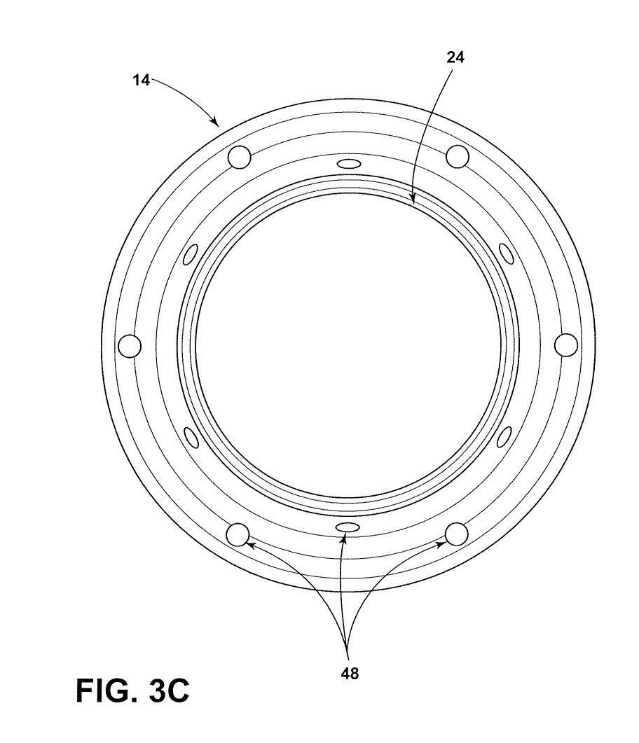

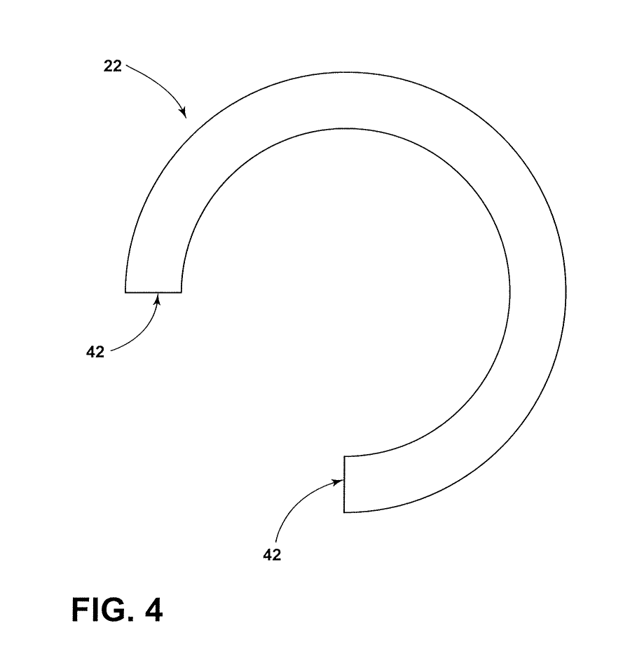

Referring now to the drawings, FIG. 1 generally illustrates an embodiment of a spring isolator 10. Spring isolator 10A may include an outer shell 12, an insert (e.g., an insert 14; see FIGS. 2B, 3A-3B, 5A-5B, 7), a spring track (hereinafter referred to as “track/groove”) 16, an outer wall 18, an inner wall 20, an inner ring 24, and/or an alignment guide 30. Outer shell 12 may be configured (e.g., molded), of a flexible material (e.g., rubber, microcellular urethane). Outer shell 12 may include an alignment guide 30 that may engage a portion of a coil spring (e.g., a coil spring 22; see FIGS. 4, 8, 9). Outer shell 12 may be configured to include a track/groove 16, an outer wall (e.g., an outer wall 18; see FIGS. 2A-2C, 3A), an inner wall 20, and/or an inner ring 24. Track/groove 16 may be configured to connect with outer wall 18, inner wall 20, and/or alignment guide 30. Inner ring 24 may be configured to include one or more splines 26 (e.g., see FIGS. 2A-2D, 3A). Splines 26 may be configured to engage a body stub 28 (e.g., see FIGS. 3A, 5A-5B, 6-8). In embodiments, splines 26 may be configured to permit water and/or other foreign material to evacuate (e.g., exit), the space between splines 26 and/or body stub 28.

FIGS. 2A-2D generally illustrate another embodiment, spring isolator 10B. In embodiments, an outer shell 12 of spring isolator 10B may be formed (e.g. molded), of a flexible material (e.g., microcellular urethane). In embodiments, an insert 14 may be included within (e.g., disposed within, encompassed by, over-molded), outer shell 12. In embodiments, insert 14 may be configured of a moldable material (e.g., polymer, metal). In embodiments, insert 14 may include one or more flow (or bonding) holes (flow holes 48; see, e.g., FIG. 3B-3C). In embodiments, insert 14 may include one or more flow holes 48 through which a flexible material (e.g., microcellular urethane), of outer shell 12 may flow.

In embodiments, an insert 14 of a spring isolator 10A, 10B may include an inner portion 36, an outer portion 38, and/or an angled (or transition) portion 40 (e.g., see FIG. 2B). In embodiments, moving concentrically from inner ring 24 outward, insert 14 may be configured as follows: inner ring 24, inner portion 36, angled portion 40, and/or outer portion (an outer portion 38; see, e.g., FIG. 2B).

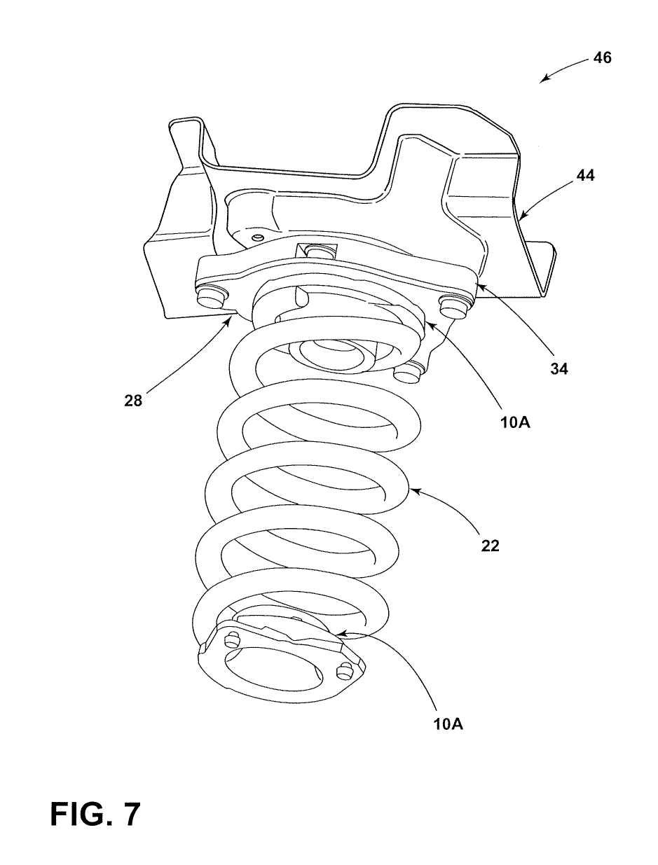

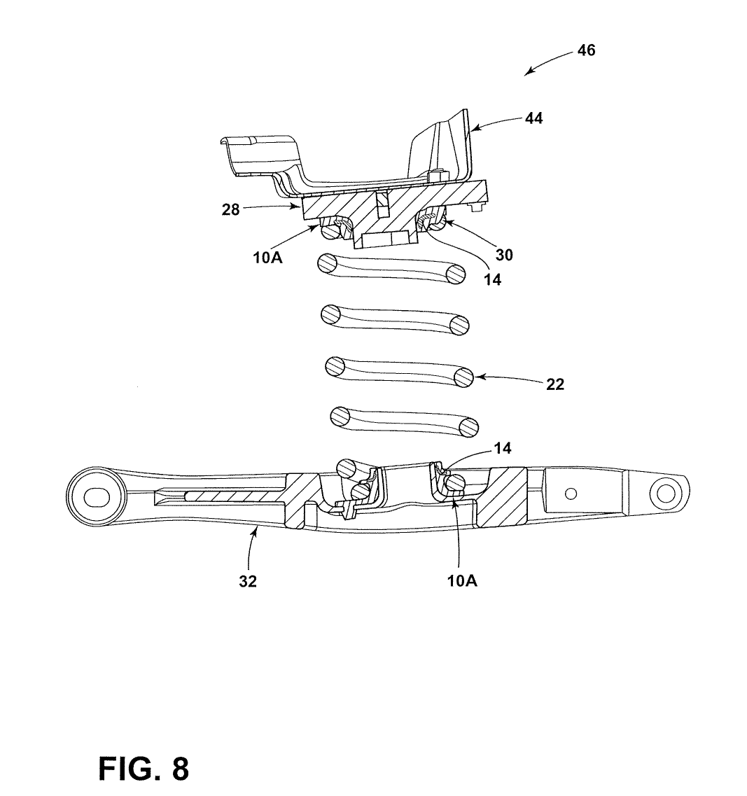

In embodiments, an inner portion 36, an outer portion 38, and/or an angled portion 40 of an insert 14 may restrict (e.g., prevent), the movement (e.g., lateral, fore/aft), of a coil spring 22 relative to spring isolator 10A, 10B and/or a vehicle suspension 46 (see, e.g., FIGS. 7-8). For example, in operation, a coil spring 22 may tighten (e.g., decrease in coil radius), as it approaches a body stub 28, particularly as coil spring 22 may be compressed and/or expanded. As a result of the tightening (e.g., contraction), of coil spring 22 toward body stub 28, spring isolator 10A, 10B may also be contorted (e.g., deformed), by coil spring 22. Insert 14, however, reinforces spring isolator 10 and/or restricts (e.g., resists), the deformation of spring isolator 10A, 10B by coil spring 22. By reinforcing and/or restricting the deformation of spring isolator 10A, 10B, insert 14 may minimize any adverse effects on the performance of a vehicle suspension 46, such as, but not limited to, additional jounce and/or rebound and/or other upsetting suspension movements.

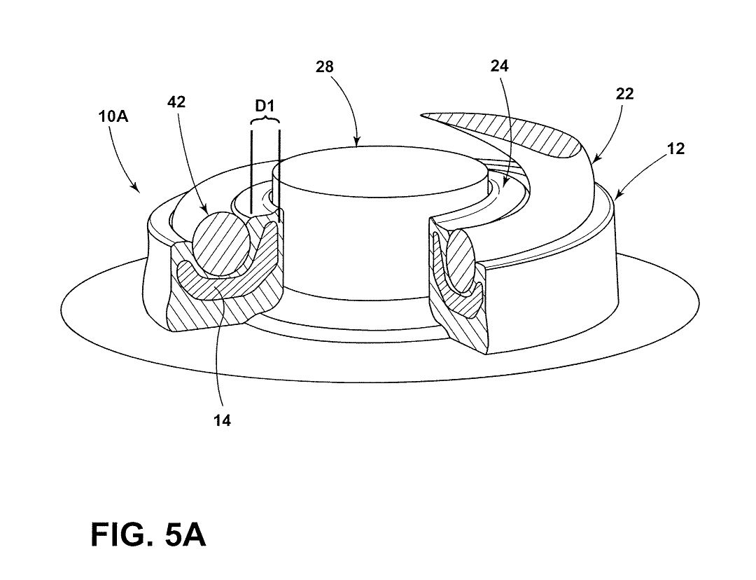

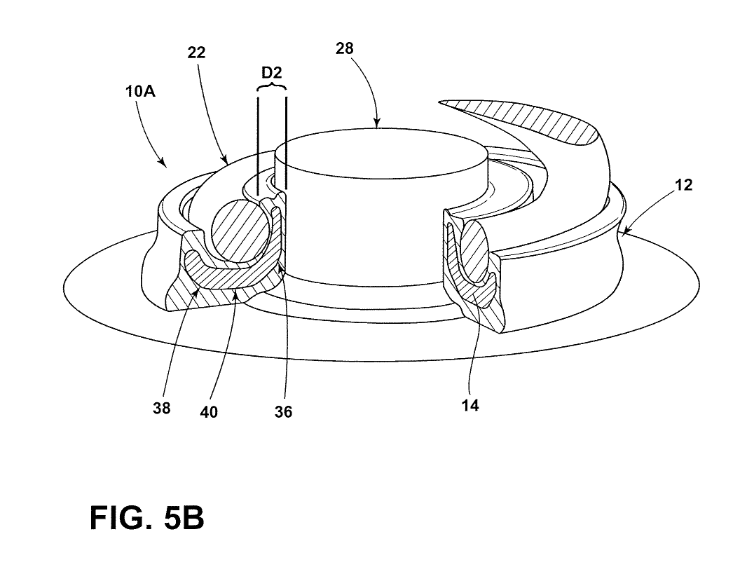

In embodiments, an inner portion 36, an outer portion 38, and/or an angled portion 40 of an insert 14 may dissipate (e.g., distribute), the load (e.g., energy, force), transferred from coil spring 22 (e.g., see FIGS. 4, 5A-5B), to spring isolator 10A, 10B. Spring isolator 10A, 10B may also restrict (e.g., control), the movement of coil spring 22 and/or vehicle suspension 46 (e.g., see FIGS. 7-8), during compression (e.g., jounce), and/or expansion (e.g., rebound), that may result in undesired movement of coil spring 22 and/or vehicle suspension 46.

For example and without limitation, inner portion 36, closest to body stub 28, may resist a radial force that may be generated by coil spring 22 and/or vehicle suspension 46. Additionally and/or alternatively, outer portion 38, closest to coil spring 22, may resist a radial force that may be generated by coil spring 22 and/or vehicle suspension 46. The combined and/or separate interaction between coil spring 22 and inner portion 36 and/or outer portion 38 may maintain coil spring 22 in a predetermined position that may result in improved operation of vehicle suspension 46.

Referring to FIG. 2B, in embodiments, an inner portion 36, an outer portion 38, and/or an angled portion 40 of insert 14 of spring isolator 10A, 10B may resist a radial force that may be generated by coil spring 22 and/or vehicle suspension 46 (see FIGS. 7-8). The combined and/or separate interaction between coil spring 22 and inner portion 36, outer portion 38, and/or angled portion 40 may maintain coil spring 22 in a predetermined position that may result in improved operation of vehicle suspension 46.

In embodiments, spring isolator 10A, 10B may be used in one or more locations in a vehicle suspension 46 (see, e.g., FIGS. 7-8). For example and without limitation, spring isolator 10A, 10B may be used in conjunction with a MacPherson-type strut-type vehicle suspension (not shown) that may be located in the front and/or rear of a vehicle. Spring isolator 10A, 10B may be configured at either end (i.e., top or bottom), of the MacPherson-type strut system, or both. Spring isolator 10A, 10B may be configured for use in other vehicle suspension systems 46 (e.g., see, FIGS. 7-8; double wishbone suspension), that may include coil spring 22 (e.g., helical), in either front and/or rear of a vehicle.

In embodiments shown in FIGS. 2A-2C, spring isolator 10A, 10B may be engaged by coil spring 22. Coil spring 22 may engage outer shell 12, track/groove 16, outer wall 18, inner wall 20, and/or alignment guide 30. In embodiments, spring isolator 10A, 10B may dissipate (e.g., distribute), a load received from coil spring 22, either during compression (e.g., jounce), and/or expansion (e.g., rebound), of coil spring 22 and/or vehicle suspension 46. In addition to the load received and/or dissipated from coil spring 22 by spring isolator 10A, 10B, an additional load component, a radial load, may also be received and/or dissipated by spring isolator 10A, 10B. In embodiments, radial loading of coil spring 22 may restrict movement (e.g., lateral, fore/aft), of spring isolator 10A, 10B relative to body stub 28 (see, e.g., FIGS. 3A, 5A-5B, and 6), and/or vehicle suspension 46. The restriction (e.g., limitation), of movement of spring isolator 10A, 10B relative to body stub 28 and/or vehicle suspension 46 may improve the ride quality and/or operation of vehicle suspension 46.

In embodiments, spring isolator 10A, 10B may include inner ring 24. Inner ring 24 may include one or more splines 26. In embodiments, splines 26 may be configured about the inner diameter of inner ring 24. In embodiments, splines 26 may be configured to permit water and/or other foreign material to evacuate (e.g., exit), the space between splines 26 and body stub 28. In embodiments, spring isolator 10A, 10B may include an alignment guide 30. Alignment guide 30 may be configured to engage insert 14, track/groove 16, outer wall 18, inner wall 20, and/or coil spring 22.

FIG. 3A generally illustrates an embodiment of spring isolator 10B. In embodiments, spring isolator 10B may include outer shell 12 that may be formed (e.g., molded), of a flexible material (e.g., microcellular urethane). In embodiments, insert 14 may be included within (e.g., over-molded by), outer shell 12. In embodiments, insert 14 may be constructed of a material that may strengthen spring isolator 10B (e.g., polymer, metal), and/or permit a load received from coil spring 22 (e.g., see FIGS. 4, 5A-5B, 7-8), to be dissipated (e.g., distributed), via insert 14. In embodiments, other elastomers and/or composites may be used to construct insert 14.

Referring to FIGS. 3B-3C, in embodiments, insert 14 may include one or more flow holes 48 that may permit a material (e.g., foam urethane elastomer), forming outer shell 12 of spring isolator 10A, 10B to pass through the flow holes 48 and/or secure insert 14 within outer shell 12 of spring isolator 10A, 10B. In embodiments, insert 14 may include an inner portion 36, an outer portion 38, and/or an angled portion 40. In embodiments, inner portion 36 may be configured adjacent to inner ring 24. In embodiments, outer portion 38 may be configured adjacent to inner ring 24. In embodiments, angled portion 40 may be configured adjacent to inner ring 24. In embodiments, spring isolator 10A, 10B may include an inner ring 24. Inner ring 24 may include one or more splines 26 (see, e.g., FIG. 3A). In embodiments, splines 26 may be configured about the inner diameter of inner ring 24. In embodiments, splines 26 may engage body stub (e.g., a body stub 28; see FIG. 5A), a spacer (e.g., a spacer 34; see FIG. 7), vehicle chassis (e.g., a vehicle chassis 44; see FIGS. 7-8), and/or vehicle suspension 46. In embodiments, splines 26 (e.g., see FIG. 3A), may be configured to permit water and/or other foreign material to evacuate (e.g., exit), the space between splines 26 and/or body stub 28. In embodiments, spring isolator 10A, 10B may include an alignment guide 30. Alignment guide 30 may be configured to engage insert 14, track/groove 16, outer wall 18, inner wall 20, and/or coil spring 22.

FIG. 4 generally illustrates a segment of coil spring 22 (e.g., a helical end), associated with an embodiments of spring isolator 10A, 10B (see FIGS. 1, 2A-2D). While the instant illustration depicts an arc of about 270°, with other embodiments the arc may range within about 180° to about 360°. Moreover, with some embodiments, the end may have a configuration that is more squared. Coil spring 22 may include one or more coil spring ends 42. In embodiments, alignment guide 30 (e.g., see FIGS. 1, 2A, 2C, 8), of spring isolator 10A, 10B may engage coil spring end 42. Alignment guide 30 may restrict the movement (e.g., rotation), of coil spring 22. In embodiments, alignment guide 30 may restrict and/or affect the movement of coil spring 22 as a result of the compression and/or expansion of coil spring 22.

FIGS. 5A-5B generally illustrate embodiments of a spring isolator 10A. In embodiments, spring isolator 10A may include outer shell 12 formed (e.g., molded), of a flexible material (e.g., microcellular urethane). In embodiments, insert 14 may be included within outer shell 12. In embodiments, insert 14 may be configured of a flexible material (e.g., polymer). In embodiments, insert 14 may include one or more flow holes 48 through which a flexible material of outer shell 12 may flow (e.g., see FIGS. 3B-3C). In embodiments, insert 14 may include inner portion 36, outer portion 38, and/or angled portion 40 (e.g., see FIG. 5B). In embodiments, inner portion 36 may be configured adjacent to inner ring 24. In embodiments, outer portion 38 may be configured adjacent to inner ring 24. In embodiments, angled portion 40 may be configured adjacent to inner ring 24. In embodiments, spring isolator 10A may include inner ring 24. Inner ring 24 may include one or more splines 26 (e.g., see FIGS. 2A-2D, 3A). In embodiments, inner ring 24 and/or splines 26 may engage body stub 28, spacer 34, vehicle chassis 44, and/or vehicle suspension 46. In embodiments, splines 26 may be configured to permit water and/or other foreign material to evacuate (e.g., exit), the space between splines 26, body stub 28, spacer 34, vehicle chassis 44, and/or vehicle suspension 46 (e.g., see FIG. 3A).

As generally illustrated in FIG. 5A, in embodiments, coil spring 22 may be subjected to a jounce (e.g., compression), load that may cause coil spring 22 to move a distance D1 relative to spring isolator 10A. For example and without limitation, during a jounce load, coil spring 22 may move distance D1 away from inner portion 36 of insert 14, but may be restricted from doing so due to the load being proportioned (e.g., consistently distributed), by insert 14 within spring isolator 10A. Additionally and alternatively, inner portion 36, outer portion 38, and/or angled portion 40 of insert 14 may restrict and/or resist radial motion.

As generally illustrated in FIG. 5B, in embodiments, coil spring 22 may be subjected to a rebound (e.g., jounce and radial), load that may cause coil spring 22 to move a distance D2 relative to spring isolator 10A. For example and without limitation, during a rebound load, coil spring 22 may move distance D2 (which may be smaller than distance D1) toward an inner portion 36 of insert 14, but may be restricted from doing so due to the load being proportioned by insert 14 within spring isolator 10A. Additionally and alternatively, inner portion 36, outer portion 38, and/or angled portion 40 of insert 14 may restrict and/or resist radial motion.

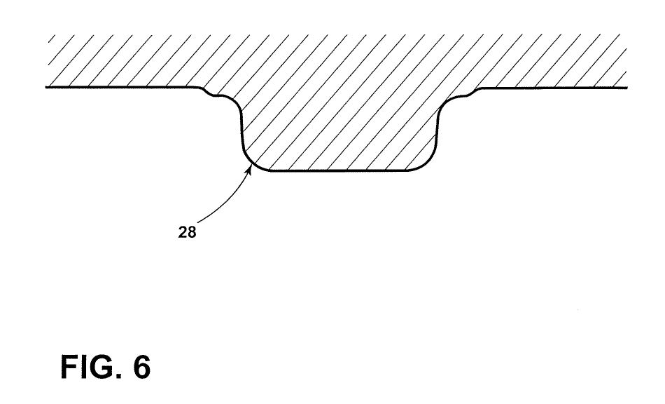

FIG. 6 generally illustrates body stub 28 associated with embodiments of spring isolator 10A, 10B. In embodiments, spring isolator 10A, 10B may engage body stub 28. In embodiments, inner ring 24 (e.g., see FIGS. 1, 2A-2D, 3A-3B, 5A-5B, 7-8), of spring isolator 10A, 10B may engage body stub 28. In embodiments, one or more splines 26 (e.g., see FIGS. 2A-2D, 3A), of spring isolator 10A, 10B (e.g., see FIGS. 1, 2A-2D), may engage body stub 28. In embodiments, inner ring 24 may include one or more splines 26 that may engage body stub 28. It should be understood that body stub 28 is not an exclusive engagement for spring isolator 10A, 10B, but only an exemplary engagement. For example and without limitation, spring isolator 10A, 10B may engage body stub 28, a spacer 34 (e.g., see FIG. 7), vehicle chassis 44, and/or vehicle suspension 46 (e.g., see FIGS. 7-8).

FIGS. 7-8 generally illustrate vehicle chassis 44 and/or vehicle suspension 46 associated with embodiments of spring isolator 10A, 10B. In embodiments, spring isolator 10A, 10B may be configured to engage coil spring 22, body stub 28, control arm 32, spacer 34, vehicle chassis 44, vehicle chassis 44, and/or vehicle suspension 46. In embodiments, control arm 32 may include other components of a vehicle suspension (e.g., strut), 46.

In embodiments, spring isolator 10A, 10B may include an insert 14 (e.g., see FIGS. 3A-3C, 5A-5C). In embodiments, spring isolator 10A, 10B may include one or more splines 26 (e.g., see FIGS. 2A-2D, 3A). In embodiments, one or more splines 26 may engage body stub 28, control arm 32 (e.g., see FIG. 8), spacer 34 (e.g., see FIG. 7), vehicle chassis 44, and/or vehicle suspension 46 (e.g., see FIGS. 7-8). Splines 26 may engage body stub 28, control arm 32,vehicle chassis 44, and/or vehicle suspension 46 via a press (e.g., interference), fitting that may deform one or more splines 26 of spring isolator 10B. In embodiments, spring isolator 10A that may include inner ring 24 (e.g., see FIGS. 1, 2A-2D, 3A-3B, 5A-5B), that may be devoid of splines 26. For example, spring isolator 10A may include inner ring 24 with a smooth (e.g., spline-free), inner surface. In embodiments, spring isolator 10A with inner ring 24 devoid of splines 26 may engage body stub 28, control arm 32, spacer 34, vehicle chassis 44, and/or vehicle suspension 46.

In embodiments, spring isolator 10A, 10B may engage body stub 28, control arm 32, spacer 34, vehicle chassis 44, and/or vehicle suspension 46 via other mechanical fasteners (e.g., adhesives, rivets, and/or bolts). In embodiments, one or mechanical fastener may be used by spring isolator 10A, 10B to engage body stub 28, control arm 32, spacer 34, vehicle chassis 44, and/or vehicle suspension 46. For example, an adhesive may be applied to splines 26 of spring isolator 10B that may improve and/or enhance the joining of spring isolator 10B with body stub 28, control arm 32, spacer 34, vehicle chassis 44, and/or vehicle suspension 46. In embodiments, one or more splines 26 of spring isolator 10B may be configured to permit water and/or other debris to exit the space between splines 26 and body stub 28, control arm 32, spacer 34, vehicle chassis 44, vehicle suspension 46. In embodiments, one or more splines 26 (e.g., see FIG. 2D), of spring isolator 10B may be configured to facilitate manufacturing (e.g., molding). It should be noted that spring isolator 10A, 10B may be configured to engage either side of coil spring 22. For example and without limitation, in embodiments, spring isolator 10A, 10B may engage the top (e.g., upper), portion of coil spring 22 and/or spring isolator 10A, 10B may engage the bottom (e.g., lower), portion of coil spring 22. It should be understood that, for example, spring isolator 10A may engage the top portion of coil spring 22 and spring isolator 10B may engage the bottom portion of coil spring 22 as but one of many possible configurations. In other embodiments, spring isolator 10A or spring isolator 10B may only engage either a top or bottom portion of coil spring 22.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Although only certain embodiments have been described above with a certain degree of particularity, those skilled in the art could make numerous alterations to the disclosed embodiments without departing from the scope of this disclosure. All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments. Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. It is intended that all matter contained in the above description or shown in the accompanying drawings shall be interpreted as illustrative only and not limiting. Changes in detail or structure may be made without departing from the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

While one or more particular embodiments have been shown and described, it will be understood by those of skill in the art that various changes and modifications can be made without departing from the spirit and scope of the present teachings.

What is claimed is:

1. A spring isolator assembly, the assembly comprising:
an outer shell, wherein the outer shell includes a spring track and an inner wall for receiving a spring; and
an insert, wherein the insert is disposed within the outer shell and includes an angled portion disposed between an inner portion and an outer portion.

2. The spring isolator assembly of claim 1, wherein the insert includes a plurality of holes configured to receive the outer shell.

3. The spring isolator assembly of claim 1, wherein the insert is constructed of a polymer or a metal.

4. The spring isolator assembly of claim 1, wherein the outer shell includes an inner ring disposed adjacent to the inner wall.

5. The spring isolator assembly of claim 1, wherein the outer shell is constructed of rubber, microcellular urethane, or foam urethane elastomer.

6. The spring isolator assembly of claim 1, wherein the outer shell includes an alignment guide for engaging an end of the spring.

7. The spring isolator assembly of claim 6, wherein the alignment guide is disposed on the spring track and the inner wall.

8. The spring isolator assembly of claim 1, wherein the outer shell and the insert are configured to restrict the movement of the spring relative to at least one of the spring isolator assembly and a vehicle suspension.

9. The spring isolator assembly of claim 1, wherein the spring isolator assembly engages at least one of a body stub, a vehicle chassis, and a vehicle suspension via at least one of an interference fitting, an adhesive, a rivet, and a bolt.

10. A spring isolator assembly, the assembly comprising:
an outer shell, wherein the outer shell includes a spring track, an inner wall, and an outer wall for receiving a coil of a spring, wherein the spring track is disposed between the inner wall and the outer wall; and
an insert, wherein the insert is disposed within the outer shell and includes an angled portion disposed between an inner portion and an outer portion.

11. The spring isolator assembly of claim 10, wherein the insert includes a plurality of holes configured to receive the outer shell.

12. The spring isolator assembly of claim 10, wherein the insert is constructed of a polymer or a metal.

13. The spring isolator assembly of claim 10, wherein the outer shell includes an inner ring disposed adjacent to the inner wall.

14. The spring isolator assembly of claim 10, wherein the outer shell includes at least one spline configured about the inner diameter of the inner ring.

15. The spring isolator assembly of claim 14, wherein the at least one spline is configured to selectively engage at least one of a body stub, a vehicle chassis, and a vehicle suspension.

16. The spring isolator assembly of claim 15, wherein the at least one spline is configured for evacuation of at least one of water and debris between the at least one spline and the at least one of a body stub, a vehicle chassis, and a vehicle suspension.

17. The spring isolator assembly of claim 10, wherein the outer shell is constructed of rubber, microcellular urethane, or foam urethane elastomer.

18. The spring isolator assembly of claim 10, wherein the outer shell includes an alignment guide for engaging an end of the spring.

19. The spring isolator assembly of claim 18, wherein the alignment guide is disposed between the inner wall, the spring track, and the outer wall.

20. The spring isolator assembly of claim 10, wherein the outer shell and the insert are configured to restrict the movement of the spring relative to at least one of the spring isolator assembly and a vehicle suspension.

21. The spring isolator assembly of claim 10, wherein the spring isolator assembly engages at least one of a body stub, a vehicle chassis, and a vehicle suspension via at least one of an interference fitting, an adhesive, a rivet, and a bolt.
